(19) United States
(12) Patent Application Publication
(10) Pub. No.: US 2011/0169403 A1
(43) Pub. Date: Jul. 14, 2011

(54) NON-LEAD GLASS FOR COVERING ELECTRODES AND PLASMA DISPLAY DEVICE

(75) Inventors: Kenji IMAKITA, Tokyo (JP); Yasuko Osaki, Tokyo (JP); Satoshi Fujimine, Tokyo (JP)

(73) Assignee: Asahi Glass Company, Limited, Chiyoda-ku (JP)

(21) Appl. No.: 13/070,534

(22) Filed: Mar. 24, 2011

Related U.S. Application Data
(63) Continuation of application No. PCT/JP09/67510, filed on Oct. 7, 2009.

(30) Foreign Application Priority Data
Oct. 9, 2008 (JP) 2008-262885

(51) Int. Cl. H01J 17/49; C03C 3/089

(52) U.S. Cl. 313/582; 501/65

(57) ABSTRACT

To provide non-lead glass for covering electrodes, whereby the strength of front substrates of plasma display devices can be improved, and the dielectric constant can be made small.

Non-lead glass for covering electrodes, which comprises, as represented by mol % based on the following oxides, from 42 to 52% of B₂O₃, from 40 to 48% of SiO₂, from 3.5 to less than 7% of K₂O and from 0 to 6% of ZrO₂, wherein the total content of B₂O₃ and SiO₂ is at least 88%. Further, a plasma display device comprising a front glass substrate to be used as a display surface, a rear glass substrate and barrier ribs to define cells, wherein transparent electrodes formed on the front glass substrate or the rear glass substrate are covered with the above non-lead glass for covering electrodes.

### BACKGROUND OF THE INVENTION

1. Field of the Invention

The present invention relates to non-lead glass for covering electrodes, which is suitable for producing e.g. a front substrate of a plasma display device (PDP), a glass substrate provided with electrodes, and a PDP.

2. Discussion of Background

PDP is a representative large-screen full-color display device.

PDP is produced in such a manner that a front substrate to be used as a display surface and a rear substrate having a plurality of stripe- or waffle-shaped barrier ribs formed thereon are sealed as faced with each other, and discharge gas is introduced between such substrates.

The front substrate is one in which a plurality of display electrode pairs for inducing surface discharge are formed on a front glass substrate, and the electrode pairs are covered with transparent glass dielectrics. Electrode pairs usually consist of transparent electrodes made of e.g. ITO, and bus electrodes to be formed on a part of the surface of the transparent electrodes. As the bus electrodes, silver electrodes, Cr—Cu—Cr electrodes, etc. are used.

On the rear substrate, barrier ribs and fluorescent layers are formed, in addition to electrodes.

The glass (dielectrics) for covering electrodes on the front substrate, is formed by e.g. a method of transferring a green sheet containing a glass powder onto the electrodes, followed by firing, or applying a paste containing a glass powder on electrodes, followed by firing.

The barrier ribs are produced by a method such that a paste containing a glass powder and as a case requires, a refractory ceramic filler or a glass filler having a high melting point, is applied, and a dry film is masked, and sand-blasted for patterning; or a method such that a photosensitive paste is preliminarily applied and then exposed to light for patterning.

The glass for forming a dielectric layer on the front substrate is required to be able to be fired at a low temperature, to have high transparency after firing, and to have no stain by silver which diffuses from the silver electrodes. Further, in order to reduce electric power consumption of PDP, it is effective to lower the dielectric constant of the electrode-covering layer, and it is particularly effective to lower the dielectric constant of a glass layer which covers electrodes on a front substrate. Similarly in some cases, it is effective to lower the dielectric constant of barrier ribs formed on a rear substrate by firing glass in order to reduce electric power consumption.

Further, lately, along with the production of a large-sized plasma TV, the weight of a glass substrate has been brought up as an issue, and it has been studied to use a thinner glass substrate. However, in such a case, there is a concern such that the strength of the substrate may decrease. Therefore, in order to increase the strength of a PDP front substrate, it has been proposed to reduce the expansion coefficient of an electrode-covering layer (Non-patent Document 1).

Further, the following glass has also been proposed. That is, with respect to the linear expansion coefficients α_{A} and α_{B}, of the glass substrate and non-lead glass for covering electrodes, it is possible to prevent warpage or breakage of the front substrate by satisfying (α_{A}−20×10⁻⁷/° C.)≦α_{B}≦α_{A} to bring the remaining stress of the glass substrate to be from −800 to +1,500 psi. Such non-lead glass for covering electrodes is particularly preferably one having a composition comprising, based on mass %, from 10 to 45% of B₂O₃, from 0.5 to 20% of SiO₂, from 20 to 55% of ZnO, from 3 to 20% of K₂O, from 0 to 10% of Na₂O, from 0 to 5% of CuO+Bi₂O₃+Sb₂O₃+CeO₂+MnO, and from 0 to 30% of Nb₂O₃+La₂O₃+WO₃ (Patent Document 1).

Further, this proposal is also considered to be intended that the front substrate is desired to have high strength by lowering the thermal expansion coefficient of non-lead glass for covering electrodes.

3. Background Art

Patent Document 1: JP-A-2006-221942

Non-Patent Document 1: 2007 SID INTERNATIONAL SYMPOSIUM DIGEST pp 389-392

### SUMMARY OF THE INVENTION

The present inventors have applied the method suggested in Patent Document 1, to a conventional PDP glass substrate (PD 200, manufactured by Asahi Glass Company, Limited, wherein α_{A} is 83×10⁻⁷/° C., which will be hereinafter sometimes referred to as “a conventional glass substrate”). As a result, they have found that the above method does not necessarily sufficiently satisfy the current demand relating to strength. That is, when the above particularly preferred non-lead glass for covering electrodes having a composition comprising, based on mass %, 35.5% of B₂O₃, 11.5% of SiO₂, 40% of ZnO, 9% of K₂₀, 1% of Na₂O, 2% of CaO, and 1% of Al₂O₃, was used, followed by firing at 570° C. to cover the entire glass substrate, the falling ball strength H/H₀, which will be described later, was 1.3. Currently, the desired value of H/H₀ is at least 1.2, substantially at least 1.5. Therefore, although the above non-lead glass for covering electrodes satisfies the minimum requirement, the substantial requirement is not necessarily satisfied. Further, the above non-lead glass for covering electrodes has an average linear expansion coefficient α of 73×10⁻⁷/° C. within a range of from 50 to 350° C., a softening point (Ts) of 596° C., an elastic modulus (E) of 65 GPa and a specific dielectric constant (∈) of 7.1.

It is an object of the present invention to provide non-lead glass for covering electrodes which has a low dielectric constant and can improve the strength of a front substrate and a rear substrate of PDP, and a glass substrate provided with electrodes and PDP, of which electrodes on the glass substrate are covered with the non-lead glass for covering electrodes, and further glass for forming barrier ribs, which has a low dielectric constant, and a glass substrate and PDP, of which barrier ribs are made of the glass for forming barrier ribs.

### Means to Solve the Problems

The present invention provides non-lead glass for covering electrodes, which comprises, as represented by mol % based on the following oxides, from 42 to 52% of B₂O₃, from 40 to 48% of SiO₂, from 3.5 to less than 7% of K₂O and from 0 to 6% of ZrO₂, wherein the total content of B₂O₃ and SiO₂ is at least 88% (hereinafter referred to as “the glass of the present invention”).

This non-lead glass for covering electrodes has a low dielectric constant and thereby can be used for forming barrier ribs (hereinafter, may sometimes referred to as “glass for forming barrier ribs”, when barrier ribs are explained).

Further, the present invention provides PDP comprising a front glass substrate used as a display surface, a rear glass substrate and barrier ribs to define cells, wherein transparent electrodes on the front glass substrate are covered with the glass of the present invention, or the barrier ribs are made of the glass of the present invention (hereinafter may sometimes be referred to as “PDP of the present invention”).

Further, in order to form barrier ribs, as a case requires, the glass of the present invention may be used as mixed with a refractory ceramic filler or a glass filler having a high melting point. When mixed, the content of the glass of the present invention is at least 40 mass %. The content of the glass of the present invention is preferably at least 50 mass %, more preferably at least 60 mass %, most preferably at least 70 mass %.

As the refractory ceramic filler, alumina may be used. As the glass filler having a high melting point, aluminosilicate glass may be used.

In order to accomplish the above object, it is considered necessary to suppress cracks on non-lead glass for covering electrodes and on barrier ribs similarly, and find factors which influence the falling ball strength H/H₀ by measuring H/H₀. However, H, which will be described later, is one obtained by measuring the falling ball strength of a glass specimen (a glass layer-coated glass substrate) made by coating a glass substrate with a glass paste, followed by firing, and one which tends to be influenced not only by the glass substrate or the glass for covering electrodes, but also by a vehicle composition or a firing condition of the glass paste.

Now, in order to increase the accuracy in the measurement of such H, it became clear that the number of the measurements, n, needs to be at least 5. Consequently, it was difficult to employ the method of finding the factors which influence H/H₀, by measuring H/H₀, since a tremendous amount of work was required for improvement of accuracy in measuring H.

Therefore, the present inventors have conducted a research for a method which is capable of estimating H/H₀ without the measurement. As a result, they have found that strength value S and the measured falling ball strength H/H₀, are well matched as shown in FIG. 1, wherein S is obtained by calculation by the following formula by inserting an elastic modulus E (unit: GPa), a fracture toughness value Kc (unit: MPa·m^{1/2}) and an average linear expansion coefficient α (unit: 10⁻⁷/° C.) of the non-lead glass for covering electrodes, and a of a glass substrate i.e. α₀ (unit: 10⁻⁷/° C.). By carrying out the study by using such a method, namely, a method to estimate H/H₀ by using S, the present invention has been accomplished.

Further, with respect to the calculation for S, when α₀ is, for example, 83×10⁻⁷/° C., α₀ in the following formula is represented by 83, and the same applies to E, Kc and α. Further, H/H₀ is approximately S±0.2.

S=[13.314×Kc+0.181×(α₀−α)]²/E

FIG. 1 is obtained by using a conventional glass substrate as the glass substrate. The abscissa represents the above S, and the ordinate represents the above H/H₀. Further, the compositional ranges, as represented by mass %, of the non-lead glass for covering electrodes used for preparing FIG. 1, are from 5 to 41% of B₂O₃, from 1 to 55% of SiO₂, from 0 to 40% of ZnO, from 0 to 9% of Li₂O, from 0 to 5.5% of Na₂O, from 0 to 7.5% of K₂O, from 0 to 7% of Al₂O₃, from 0 to 10% of MgO, from 0 to 12% of BaO, from 0 to 6% of TiO₂, from 0 to 16% of Bi₂O₃ and from 0 to 35% of PbO.

E, Kc and α are, respectively, values of the physical properties of the non-lead glass for covering electrodes itself, and they are not influenced by a vehicle composition or a firing condition of the glass paste. Therefore, in such a method to estimate H/H₀, there is no such problem as mentioned above in measuring H.

Here, E, Kc and α of a sintered body containing a filler are influenced by the filler. However, the content of the filler is restricted at a level such that a dense fired body is formed. Within such a range, the influence of the filler on E and Kc of a sintered body containing a filler is small, and values of E and Kc close to those of glass. Its reason is considered to be such that glass is the main component within the range that dense firing is possible, and the properties of the glass which is the matrix are dominant for dynamic properties. α almost corresponds to a calculated value based on respective values of glass and a filler in accordance with volume fraction. That is why a filler component of which α exceeds 90 (unit: 10⁻⁷/° C.) should not be used. Typically, alumina is used, and its α is about 72 (unit: 10⁻⁷/° C.).

Kc is measured, for example, as follows.

Molten glass is poured into a stainless steel frame and annealed. Then, the annealed glass is formed into a plate-form glass, and its one side is mirror-polished, thereby to obtain a glass specimen having a typical size of 50 mm×50 mm and a thickness of 10 mm.

By using such a glass specimen, Kc is measured in accordance with JIS R 1607-1995 “Testing methods for fracture toughness of fine ceramics 5.1 IF method (indenter pressing method)”. That is, by using a Vickers hardness tester, inside a globe box having a relative humidity of 35%, a Vickers indenter is pressed against the surface of the glass specimen for 15 seconds, and the diagonal length of indentation and cracking length are measured by using a microscope attached to the tester. The Vickers hardness (Hv) is obtained from the pressing load and the diagonol length, and Kc is calculated from the cracking length, Hv, E and the pressing load. The pressing load is, for example, from 100 g to 2 kg.

α is measured, for example, as follows.

Annealed glass is formed into a cylindrical form having a length of 20 mm and a diameter of 5 mm, and the average linear expansion coefficient α from 50 to 350° C. is measured by using quarts glass as standard and a horizontal differential detection system thermal dilatometer TD 5010SA-N manufactured by Brucker AXS K.K.

E is measured, for example, as follows.

Annealed glass is formed into a plate-form having a thickness of 10 mm, and the elastic modulus E is measured by JIS R 1602-1995 “Testing methods for elastic modulus of fine ceramics 5.3 Ultrasonic pulse method”.

H/H₀ is measured as follows.

Typically, a glass substrate having a size of 100 mm×100 mm and a thickness of 2.8 mm, is placed on a water-resistant polishing paper having a production particle size of #1500. From a height of 10 cm from the upper surface of the glass substrate, 22 g of a stainless steel ball is dropped. If the glass substrate does not break by the drop of the stainless steel ball, the dropping height is adjusted to be 10 mm higher, and the stainless steel ball is dropped again. Until the glass substrate breaks, the dropping height is adjusted to be higher by 10 mm each time, and the stainless steel ball is then dropped.

Such a breaking test of glass substrate is carried out for five times, and an average value of the obtained breaking heights is represented by H₀.

H is an average value of breaking heights measured in the same manner as for H₀, with respect to a glass layer-coated glass substrate having one surface of the glass substrate covered with non-lead glass for covering electrodes.

That is, H is an average value of breaking heights obtained by carrying out the breaking test of the glass layer-coated glass substrate for five times in the same manner as H₀ measurement, except that the surface covered with non-lead glass for covering electrodes is faced down and put on the above water-resistant polishing paper.

The above glass layer-coated glass substrate is produced as follows.

100 g of a powder of the non-lead glass for covering electrodes is kneaded with 25 g of an organic vehicle having 10 mass % of ethyl cellulose dissolved in α-terpineol or the like, to prepare a glass paste. The paste is uniformly screen-printed on a glass substrate having a size of 100 mm×100 mm so that a film thickness after firing would be 20 μm, and dried at 120° C. for 10 minutes. Then, such a glass substrate is heated at a temperature-raising rate of 10° C. per minute up to Ts of the non-lead glass for covering electrodes or a temperature in a range of from (Ts —50° C.) to Ts, and maintained at the temperature for 30 minutes to carry out firing, whereby a glass layer is formed on the glass substrate, which is regarded as a glass layer-coated glass substrate.

### Effects of the Invention

According to the present invention, non-lead glass for covering electrodes which has a high strength and a low dielectric constant can be produced, a front substrate and a rear substrate for PDP can be produced by firing at a low temperature by using the non-lead glass for covering electrodes, and its strength can be improved.

Further, it is possible to lower the dielectric constant of non-lead glass for covering electrodes for PDP front substrates and the dielectric constant of glass for forming barrier ribs for rear substrates, whereby electric power consumption of PDP can be reduced.

### BRIEF DESCRIPTION OF THE DRAWING

FIG. 1 is a graph showing the relation between the calculated value and the measured value of the falling ball strength of a glass layer-coated glass substrate.

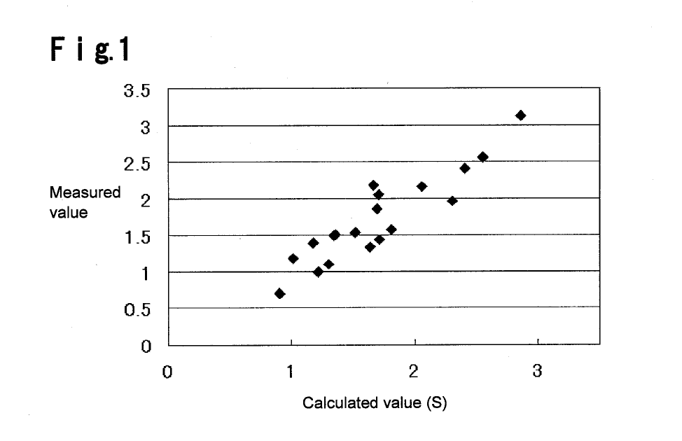

### DETAILED DESCRIPTION OF THE PREFERRED EMBODIMENTS

The glass of the present invention is suitable when a of the glass substrate i.e. α₀ is from 78×10⁻⁷ to 88×10⁻⁷/° C., particularly from 80×10⁻⁷ to 86×10⁻⁷/° C.

The glass of the present invention is usually subjected to dry grinding and classified, and used in the form of a powder for covering electrodes or forming barrier ribs.

In a case where electrodes are to be covered with a glass paste, the powdered glass of the present invention (hereinafter referred to as “the glass powder of the is present invention”) is kneaded with a vehicle to obtain a glass paste. The glass paste is applied on a glass substrate on which electrodes such as transparent electrodes are formed, and fired to form a glass layer for covering the transparent electrodes.

In a case where electrodes are to be covered with a green sheet, the glass powder of the present invention is kneaded with a resin, and the kneaded product obtained is applied on a supporting film such as a polyethylene film to obtain a green sheet. This green sheet is transferred onto electrodes formed on a glass substrate, for example, and fired to form a glass layer for covering the electrodes.

In a case where barrier ribs are formed by using a glass paste, as a case requires, a refractory ceramic filler or a glass filler having a high melting point is added to the glass powder of the present invention, followed by mixing with a vehicle. The glass paste is applied on a glass substrate on which rear electrodes and a rear dielectric layer are formed, dried and subjected to masking such as a dry film resist, and patterning is carried out by sand blast or the like. By firing this, barrier ribs are formed.

In a case where barrier ribs are formed by using a photosensitive glass paste, as a case requires, a refractory ceramic filler or a glass filler having a high melting point is added to the glass powder of the present invention, followed by mixing with a vehicle having such a property as to be polymerizable by exposure to light. The photosensitive glass paste is applied on a glass substrate on which rear electrodes and a rear dielectric layer are formed, dried and subjected to masking, and patterning is carried out by ultraviolet ray irradiation or the like. After carrying out a step of washing a masked part, the glass substrate is fired, and barrier ribs are thereby formed.

Now, in the production of a PDP front substrate, such firing is carried out typically at a temperature of at most 600° C. Further, the glass substrate having a glass layer formed in such a manner is the glass substrate of the present invention.

The average particle diameter (D₅₀) of the glass powder of the present invention is preferably at least 0.5 μm. If D₅₀ is less than 0.5 μm, it may take too long time for powderization. D₅₀ is more preferably at least 0.7 μm. Further, the above average particle diameter is preferably at most 4 μm, more preferably at most 3 μm.

The maximum particle diameter of the glass powder of the present invention is is preferably at most 20 μm. If the maximum particle diameter exceeds 20 μm, the surface of the glass layer becomes so uneven as to distort an image on the PDP in the use for formation of a non-lead glass layer for covering electrodes (transparent dielectric layer) of a PDP front substrate, wherein the thickness is required to be usually at most 30 μm. Similarly, in the use for formation of barrier ribs, the surface of the glass layer becomes so uneven as to distort an image. The maximum particle diameter is more preferably at most 10 μm.

Ts of the glass of the present invention is preferably at most 625° C. If it exceeds 625° C., it may be difficult to obtain a high transmittance glass layer by the firing at a temperature of at most 600° C., and it is difficult to obtain dense barrier ribs. It is more preferably at most 620° C.

Further, Ts is preferably at least 500° C. If Ts is lower than 500° C., a resin component contained in a glass paste or a green sheet may not be sufficiently decomposed in the firing step. Ts is typically at least 590° C.

Kc of the glass of the present invention is preferably at least 0.75 MPa·m^{1/2}

Kc is a value of a physical property relating to the strength of a glass material, and it is an important element to control the strength of a glass layer. Further, it is also an important element to control the strength of a glass substrate having such a glass layer formed on its surface, such as the glass substrate of the present invention or the front substrate of PDP of the present invention.

The breaking of the PDP front substrate is considered to happen in such a manner that when an impact is exerted on the PDP front substrate, and the substrate is deformed, a glass layer which is partially in contact with barrier ribs formed on the rear substrate, crashes to such ribs and is damaged. However, since Kc of the glass of the present invention is at least, for example, 0.75 MPa·m^{1/2}, it is considered that even if the glass layer becomes damaged like above, it is rare that the damage reaches breaking. Kc is typically at least 0.9 MPa·m^{1/2}.

Similarly, the breaking of the PDP rear substrate is considered to happen in such a manner that when an impact is exerted on the PDP front substrate, and the substrate is deformed, barrier ribs formed on the rear substrate crash to the front substrate and are damaged. However, since Kc of the glass of the present invention is at least, for example, 0.75 MPa·m^{1/2}, it is considered that even if the barrier ribs are damaged like above, it is rare that the damage reaches breaking. Kc is typically at least 0.9 MPa·m^{1/2}.

E of the glass of the present invention is preferably at most 55 GPa, more preferably at most 50 GPa. The breaking of the PDP front substrate is considered to happen in the above-mentioned manner such that the barrier ribs formed on the rear zo substrate and the glass layer crash to each other, and they are damaged. Moreover, it is considered that when E of the glass layer at that time, is at most 55 GPa, the impact by the crashing is more absorbed, and damage will rarely be formed. E is typically at most 45 GPa. Even if the glass of the present invention is used as barrier ribs, since E is small, the impact by the crashing is absorbed, and damage will rarely be formed, as mentioned in the case of the front substrate.

The strength of glass material constituting the glass layer, is governed by Kc, E, etc., but in the case of the glass layer-coated glass substrate, the strength of the glass layer becomes high or low depending on the stress formed by the difference between α of the glass substrate i.e. α₀ and α of the glass layer, in the step of cooling to room temperature after the step of firing to form the glass layer. That is, when a of the glass layer is smaller than α₀, the compression stress is exerted on the surface of the glass layer, whereby the strength of the glass layer becomes high. When α is greater than α₀, the tensile stress is exerted, whereby the strength of the glass layer becomes low.

When α₀ is from 78×10⁻⁷ to 86×10⁻⁷/° C., α of the glass of the present invention is preferably at most 80×10⁻⁷/° C. If α of the glass of the present invention exceeds 80×10⁻⁷/° C., when the glass is used for covering electrodes on the glass substrate, the strength of the glass layer-coated substrate, may decrease. α of the glass of the present invention is more preferably at most 75×10⁻⁷/° C. Further, α of the glass of the present invention is typically at least 50×10⁻⁷/° C. If α of the glass of the present invention is less than 50×10⁻⁷/° C., the stress to be formed by the difference from a of the glass substrate i.e. α₀, becomes too large, whereby the substrate may be deformed or broken.

The glass of the present invention preferably has a specific dielectric constant ∈ of at most 5.5. If ∈ exceeds 5.5, when such glass is used for covering electrodes on a PDP front substrate, it is difficult to reduce electric power consumption of PDP. ∈ is more preferably at most 5.2. The glass of the present invention typically has ∈ of from 4.0 to 5.0.

Now, the composition of the glass of the present invention will be explained by employing mol percentage presentation.

B₂O₃ is a component for lowering Ts, E or E, etc. and is essential. If the content of B₂O₃ is less than 42% in glass, the above effects may be insufficient. The content of B₂O₃ is preferably at least 44%. If the content of B₂O₃ exceeds 52%, the moisture resistance may deteriorate. Further, in such a case, the glass tends to undergo phase-separation. When the moisture resistance is desired to be improved, the content of B₂O₃ in glass is preferably at most 50%, typically at most 48%.

SiO₂ is a component for forming the matrix of the glass or lowering E or E and is essential. If the content of SiO₂ is less than 40% in glass, the glass may be unstable, or ∈ may be high. The content of SiO₂ is preferably at least 41%. If the content of SiO₂ exceeds 48%, Ts becomes high. The content of SiO₂ is preferably at most 47%.

If the total content of B₂O₃+SiO₂ is less than 88%, E or Å tends to be high.

K₂O is a component for improving vitrification or lowering Ts and is essential. If the content of K₂O is less than 3.5% in glass, the glass becomes unstable. The content of K₂O is preferably at least 4%, typically at least 4.5%. If the content of K₂O is at least 7%, Å, α or E may be high.

ZrO₂ is not essential, however ZrO₂ may be contained up to 6% in order to prevent glass from phase-separation or improve the moisture resistance. If the content of ZrO₂ exceeds 6%, the glass may become unstable. The content of ZrO₂ is preferably at most 5%. In a case where ZrO₂ is contained, the content of ZrO₂ is preferably at least 0.5%, more preferably at least 1%.

In a case where ZrO₂ is contained, the total content of SiO₂ and ZrO₂ is preferably at least 44%. If the total content of SiO₂ and ZrO₂ is less than 44%, the glass may become unstable.

The glass of the present invention is basically composed of the above components, however, so long as the object of the present invention is not impaired, other components may be contained. In such a case, the total content of other components is preferably at most 5%, more preferably at most 3%. Typical examples of such components will be explained below.

Na₂O has the same effect as K₂O in some cases, and in such a case, Na₂O may be contained up to 2.5%. If the content of Na₂O exceeds 2.5%, such glass tends to undergo phase-separation, or Ts may become high in some cases. Further, the total content of Na₂O and K₂O is preferably less than 7%. If the total content of Na₂O and K₂O is at least 7%, ∈ or E may become high.

Further, if Li₂O is contained, the warpage of the glass substrate may become large, or the glass tends to undergo phase-separation. Therefore, it is preferred that Li₂O is not contained.

In a case where Li₂O or Na₂O is contained, the total content of Li₂O, Na₂O and K₂O is preferably less than 7%. If the total content of Li₂O, Na₂O and K₂O is at least 7%, E or E may become high, or Kc may become small.

When ZnO is contained, the effects such that the glass is stabilized, Ts is lowered, a becomes small, and the moisture resistance is improved, may be obtained in some cases. In such a case, ZnO may be contained up to 5%. If the content of ZnO exceeds 5%, E or E may become too high. The content of ZnO is preferably at most 3%, more preferably at most 2%.

In a case where it is desired to improve the moisture resistance, Al₂O₃ may be contained up to 5% in some cases. If the content of Al₂O₃ exceeds 5%, when silver electrodes are covered, silver stain tends to result, or a may become large. The content of Al₂O₃ is preferably at most 3%. In a case where it is desired to prevent silver stain, the content of Al₂O₃ is preferably less than 1%, and it is more preferred that Al₂O₃ is not contained.

In a case where it is desired to prevent stain of glass since the removal of binders at the time of firing is insufficient, and carbon remains in glass after firing, CuO, CeO₂ and CoO may be contained up to the total content of these three components of 3% in some cases. If the total content of CuO, CeO₂ and CoO exceeds 3%, the stain on glass becomes remarkable on the contrary. The total content is typically at most 1.5%.

In a case where at least one of these three components is contained, the content of CuO is preferably at most 1.5%, typically at most 1.2%.

As components which may be added in order to control a, Ts, the chemical stability, the glass stability and the transmittance of the glass coating layer or suppress silver stain, TiO₂, SnO₂ and MnO₂ may, for example, be mentioned.

Further, the glass of the present invention contains no PbO.

The higher H/Ho of a glass substrate provided with a glass layer made of the glass of the present invention on one surface of the glass substrate is, the more preferred. The strength value S is preferably at least 3.0, more preferably at least 5.

### EXAMPLES

Now, the present invention will be described in further detail with reference to Examples. However, it should be understood that the present invention is by no means restricted to such specific Examples.

Starting materials were formulated and mixed so that glass would be the composition shown by mol % in lines from B₂O₃ to CuO in Table 1. Each mixture was heated to 1,250° C. and melted for 60 minutes by means of a platinum crucible. Examples 1 to 5 are working examples, and Examples 6 and 10 are comparative examples.

Among them, since the glass samples obtained in Examples 9 and 10 were semitransparent and phase-separated, the after-mentioned measurements were not carried out for them. Further, in Table 2, the composition of each glass is shown by mass %.

A part of the obtained molten glass was poured into stainless-steel rollers to be processed into flakes. The glass flakes obtained were subjected to dry grinding for 16 hours by an alumina ball mill, followed by airflow classification, to prepare a glass powder having a D₅₀ of from 2 to 4 μm.

Using this glass powder as a sample, Ts (unit: ° C.) was measured by means of a differential thermal analyzer (DTA).

The rest of the above molten glass was poured into a stainless-steel frame and annealed. A part of the annealed glass was processed into a cylindrical shape with a length of 20 mm and a diameter of 5 mm, and using a quartz glass as a standard sample, α (unit: 10⁻⁷/° C.) of such a glass was measured by using a horizontal differential detection system thermal dilatometer, TD 5010SA-N, manufactured by Bruker AXS.

Another part of the annealed glass was processed into a plate-shape having a thickness of 4 mm, and the elastic modulus E (unit: GPa) was measured by using an ultrasonic precision thickness gage “35 DL”, manufactured Olympus corporation in accordance with JIS R 1602-1995 “Testing methods for elastic modulus of fine ceramics 5.3 Ultrasonic pulse method”.

Further, one side of the above glass which was processed into a plate-shape, was mirror-polished, and in order to remove the remaining stress, the glass was held at a temperature of from 500° C. to 520° C. for one hour and then annealed. By using such a specimen, Kc (unit: MPa·m^{1/2}) was measured by the above method. Here, the pressing load of the Vickers indenter was set to be 2,000 g.

Further, Kc of the samples obtained in Examples 2 and 3 could not be measured by the above method. However, the Vickers indenter was pressed into the samples with the load of 2,000 g ten times, and then the number of cracks extending from four corners of the pressed part was measured. The number of cracks was few. Materials on which few cracks are formed tend to have a high Kc. In fact, values of Kc estimated from the compositions of the samples of Examples 2 and 3 are shown in Table, and they are high values at a level of at least 0.9 MPa·m^{1/2}.

By using values of E, Kc and α, which were obtained in the above manner, and using a value of α₀ of the glass substrate, the above S was calculated.

Further, both surfaces of a plate sample having a thickness of 3 mm were provided with circular electrodes having a diameter of 38 mm, and the specific dielectric constant (Å) was measured at 1 MHz by using a LCR meter 4192A, manufactured by YOKOKAWA Hewlett-Packard Company.

The results of measurements or calculation are shown in Tables. “-” in Tables means that measurements were not carried out. Values provided with “*” are values estimated from the glass composition.

TABLE 1

| Ex. | 1 | 2 | 3 | 4 | 5 | 6 | 7 | 8 | 9 | 10 |
|---|---|---|---|---|---|---|---|---|---|---|
| B₂O₃ | 48.0 | 45.0 | 46.0 | 49.8 | 44.8 | 45.0 | 41.0 | 47.0 | 53.0 | 46.0 |
| SiO₂ | 45.0 | 45.8 | 44.0 | 41.8 | 46.8 | 45.0 | 41.0 | 46.5 | 45.0 | 44.0 |
| ZnO | 0 | 2 | 0 | 0 | 0 | 0 | 8 | 0 | 0 | 0 |
| Na₂O | 0 | 0 | 0 | 0 | 0 | 2.5 | 4 | 3 | 0 | 0 |
| K₂O | 6.4 | 6.8 | 5 | 5 | 5 | 3 | 6 | 3 | 2 | 3 |
| ZrO₂ | 0 | 0 | 4 | 3 | 3 | 4 | 0 | 0 | 0 | 7 |
| CuO | 0.6 | 0.4 | 1.0 | 0.5 | 0.5 | 0.5 | 0 | 0.5 | 0 | 0 |
| B₂O₃ + SiO₂ | 93 | 90.8 | 90 | 91.6 | 91.6 | 90 | 82 | 93.5 | 98 | 90 |
| Ts (° C.) | 611 | 617 | 618 | 609 | 612 | 630 | 615 | 640 | — | — |
| α (×10⁻⁷/°C.) | 69 | 63 | 40 | 52 | 53 | 52 | 70 | 60 | — | — |
| E (GPa) | 38 | 43 | 43 | 40 | 40 | 45 | 57 | 40 | — | — |
| Kc (MPa · m^{1/2}) | 0.95 | 0.91* | 1.10* | 1.12 | 1.12 | 1.2 | 0.74 | 0.98 | — | — |
| S | 6.1 | 5.8* | 11.7* | 10.5 | 10.3 | 10 | 2.6 | 7.4 | — | — |
| ε | 4.7 | 4.3 | 4.8 | 4.8 | 4.8 | 4.8 | 5.9 | 4.6 | — | — |

TABLE 2

| Ex. | 1 | 2 | 3 | 4 | 5 | 6 | 7 | 8 | 9 | 10 |
|---|---|---|---|---|---|---|---|---|---|---|
| B₂O₃ | 49.9 | 46.6 | 46.5 | 50.6 | 45.8 | 46.0 | 42.1 | 49.8 | 56.1 | 45.8 |
| SiO₂ | 40.4 | 41.0 | 38.4 | 36.6 | 41.3 | 39.7 | 36.3 | 42.5 | 41.1 | 37.8 |
| ZnO | 0 | 2.4 | 0 | 0 | 0 | 0 | 9.6 | 0 | 0 | 0 |
| Na₂O | 0 | 0 | 0 | 0 | 0 | 2.3 | 3.7 | 2.8 | 0 | 0 |
| K₂O | 9.0 | 9.5 | 6.8 | 6.9 | 6.9 | 4.2 | 8.3 | 4.3 | 2.9 | 4.0 |
| ZrO₂ | 0 | 0 | 7.2 | 5.4 | 5.4 | 7.2 | 0 | 0 | 0 | 12.3 |
| CuO | 0.7 | 0.5 | 1.2 | 0.6 | 0.6 | 0.6 | 0 | 0.6 | 0 | 0 |

### INDUSTRIAL APPLICABILITY

The non-lead glass for covering electrodes of the present invention is useful for PDP, a PDP front substrate, a PDP rear substrate, non-lead glass for covering electrodes on the front and rear substrates and glass for forming barrier ribs, as a glass substrate having a high strength and a low dielectric constant.

The entire disclosure of Japanese Patent Application No. 2008-262885 filed on Oct. 9, 2008 including specification, claims, drawings and summary is incorporated herein by reference in its entirety.

What is claimed is:

1. Non-lead glass for covering electrodes, which comprises, as represented by mol % based on the following oxides, from 42 to 52% of B₂O₃, from 40 to 48% of SiO₂, from 3.5 to less than 7% of K₂O and from 0 to 6% of ZrO₂, wherein the total content of B₂O₃ and SiO₂ is at least 88%.

2. The non-lead glass for covering electrodes according to claim 1, wherein the total content of SiO₂ and ZrO₂ is at least 44 mol %.

3. The non-lead glass for covering electrodes according to claim 1, which further contains at most 1.5 mol % of CuO.

4. The non-lead glass for covering electrodes according to claim 1, which further contains at most 3 mol % of ZnO.

5. The non-lead glass for covering electrodes according to claim 1, wherein when Li₂O or Na₂O is contained, the total content of Li₂O, Na₂O and K₂O is less than 7 mol %.

6. The non-lead glass for covering electrodes according to claim 1, which has a softening point of at most 625° C.

7. The non-lead glass for covering electrodes according to claim 1, which has an average linear expansion coefficient of from 50×10⁻⁷ to 75×10⁻⁷/° C. at from 50 to 350° C.

8. A plasma display device comprising a front glass substrate to be used as a display surface, a rear glass substrate and barrier ribs to define cells, wherein electrodes formed on the front glass substrate or the rear glass substrate are covered with the non-lead glass for covering electrodes as defined in claim 1.

9. A plasma display device comprising a front glass substrate to be used as a display surface, a rear glass substrate and barrier ribs to define cells, wherein the barrier ribs are made of the non-lead glass for covering electrodes as defined in claim 1.
